(19) United States
(12) Patent Application Publication
(10) Pub. No.: US 2006/0072927 A1
(43) Pub. Date: Apr. 6, 2006

(54) Optical receiver for receiving differential phase and frequency shift-keyed optical signals

(75) Inventors: Hoon Kim, Suwon-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/234,962

(22) Filed: Sep. 26, 2005

(30) Foreign Application Priority Data
Oct. 6, 2004 (KR) 2004-79528

(51) Int. Cl. H04B 10/06

(52) U.S. Cl. 398/214

(57) ABSTRACT

An optical signal receiver for receiving a differential modulated optical signal is disclosed. The optical signal receiver includes a delay interferometer for intensity-dividing the optical signal into a first and a second divided optical signal, generating a delayed optical signal by phase-delaying the second divided optical signal by one bit for the first divided optical signal, and generating interfered optical signals from the delayed optical signal and the first divided optical signal; a balanced receiver for detecting a differential electrical signal from the interfered optical signals; a power detector for detecting alternating current power of the differential electrical signal; and a phase controller for calculating a phase delay difference between the delayed optical signal and the first divided optical signal from the alternating current power detected by the power detector, and controlling the phase delay difference between the first divided optical signal and the delayed optical signal to be constantly maintained.

### CLAIM OF PRIORITY

This application claims priority to an application entitled “Optical Receiver for Receiving Differential Phase and Frequency Shift-keyed Optical Signals,” filed in the Korean Intellectual Property Office on Oct. 6, 2004 and assigned Ser. No. 2004-79528, the contents of which are incorporated herein by reference.

### BACKGROUND OF THE INVENTION

1. Field of the Invention

The present invention relates to an optical receiver and, more particularly to an optical receiver including a delay interferometer for receiving a differential modulated optical signal.

2. Description of the Related Art

Known differential modulation schemes for an optical signal range from a phase modulation scheme, a frequency modulation scheme, a polarization modulation scheme, etc. An optical receiver used to receive a differential modulated optical signal typically includes a delay interferometer, a balanced receiver for detecting data from the delay interferometer, a direct current detector, a control unit, and a control means for controlling the delay interferometer.

In operation, the delay interferometer intensity-divides the differential modulated optical signal and delays one of the divided optical signals by one bit. A constructive or destructive optical signal is generated as a result of an interference between the delayed optical signal and the non-delayed optical signals. The delay interferometer includes two or more waveguides that are arranged in the progressing paths of the divided optical signals. The waveguides have different lengths to enable one of the divided optical signals to be delayed by one bit. The delay difference of one bit between the divided optical signals is constantly maintained by the control means.

Meanwhile, the balanced receiver converts the constructive optical signal and the destructive optical signal generated by the delay interferometer into electrical signals and detects data from the electrical signals.

The direct current detector monitors whether or not a delay time difference between the waveguides contained in the delay interferometer is maintained constantly based on the direct current component of the electrical signal generated by the balanced receiver. That is, when the delay time difference between a delayed optical signal and a first divided optical signal is not maintained by one bit, the current of the converted electrical signal is reduced in the direct current detector.

The control unit compares the direct current amount detected by the direct current detector with a predetermined value and outputs a control signal for controlling the delay interferometer when the direct current amount changes.

The control means is located at one of the waveguides of the delay interferometer, applies heat or pressure to a corresponding waveguide according to the control signal of the control unit, and controls the delay time difference between the divided optical signals to always maintain one bit.

However, in order to monitor the delay time of one bit of the delay interferometer on the basis of the direct current amount, a direct current must be artificially applied to a modulated optical signal. That is, a general differential phase shift-keyed optical signal has a phase shift-keying of 0 or π. In the method of monitoring the delay time of the one bit in the delay interferometer on the basis of a direct current amount, the amount of the phase shift-keying of an optical signal is reduced by δ of π−δ. The reduction of the phase shift-keying of the differential phase shift-keyed optical signal, however, causes the deterioration of a system.

Moreover, when a mach-zehnder modulator as a phase modulator is employed as a phase shift-keying of 0 or π, it is not possible to apply the mach-zehnder modulator to an optical receiver to monitor the delay time of one bit of the delay interferometer on the basis of the direct current.

### SUMMARY OF THE INVENTION

Accordingly, the present invention has been made to solve the above-mentioned problems occurring in the prior art and provides additional advantages, by providing an optical receiver capable of detecting a differential phase shift-keyed optical signal or a differential frequency shift-keyed optical signal that do not contain a direct current component.

In accordance with one aspect of the present invention, there is provided an optical signal receiver for receiving a differential modulated optical signal comprising: a delay interferometer for intensity-dividing the optical signal into a first and a second divided optical signal, generating a delayed optical signal by phase-delaying the second divided optical signal by one bit for the first divided optical signal, and generating interfered optical signals from the delayed optical signal and the first divided optical signal; a balanced receiver for detecting a differential electrical signal from the interfered optical signals; a power detector for detecting alternating the current power of the differential electrical signal; and a phase controller for calculating a phase delay difference between the delayed optical signal and the first divided optical signal from the alternating current power detected by the power detector, and controlling the phase delay difference between the first divided optical signal and the delayed optical signal to be constantly maintained.

### BRIEF DESCRIPTION OF THE DRAWINGS

The above and other features and advantages of the present invention will be more apparent from the following detailed description taken in conjunction with the accompanying drawings, in which:

FIG. 1 is a block diagram showing an optical signal receiver according to an embodiment of the present invention;

FIG. 2 is a block diagram showing the construction of the phase controller shown in FIG. 1; and

FIG. 3 is a graph illustrating the relation of alternating current power detected by the power detector shown in FIG. 1 and a bit error ratio (‘BER)’.

### DETAILED DESCRIPTION

Hereinafter, an embodiment according to the present invention will be described with reference to the accompanying drawings. For the purposes of clarity and simplicity, a detailed description of known functions and configuration incorporated herein will be omitted as it may make the subject matter of the present invention unclear.

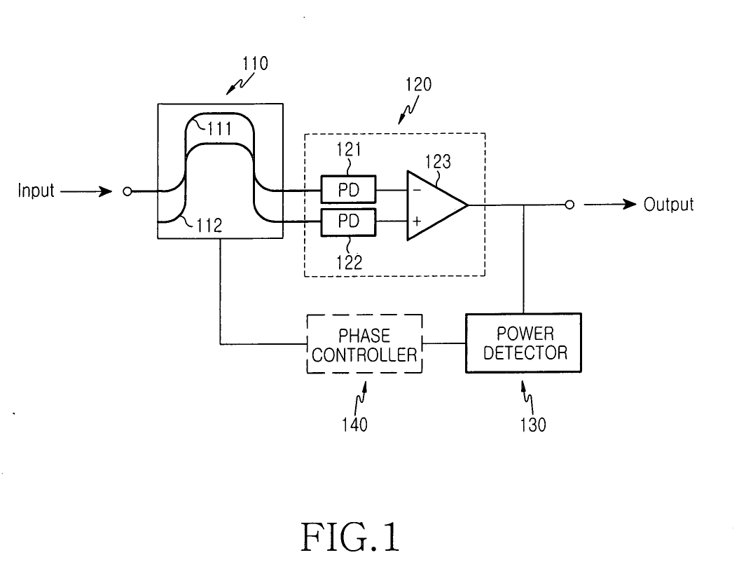

FIG. 1 is a block diagram showing an optical signal receiver according to an embodiment of the present invention. As shown, the optical signal receiver according to the present invention includes a delay interferometer 110 for generating interference optical signals from optical signals received therein, a balanced receiver 120 for detecting differential electrical signals from the interference optical signals, a power detector 130 for detecting alternating power of the differential electrical signal, and a phase controller 140. Herein, differential frequency shift-keyed optical signals or differential phase shift-keyed optical signals may be used to refer to the optical signals received by the optical signal receiver.

The delay interferometer 110 receives a differential phase shift-keyed optical signal or a differential frequency shift-keyed optical signal and converts the received optical signal into intensity information. Herein, the delay interferometer 110 may use a mach-zehnder interferometer including two or more waveguides 111 and 112 having different phase lengths, etc. The waveguides 111 and 112 have a phase length in such a degree that a second divided optical signal has a phase delay difference of one bit with respect to a first divided optical signal.

As such, the optical signal is intensity-divided into the first divided optical signal and the second divided optical signal by the delay interferometer 110 and the second divided optical signal is phase-delayed by one bit in relation to the first divided optical signal in the corresponding waveguide. When the optical signal having been delayed by one bit for the first divided optical signal has the same phase as that of the first divided optical signal, a constructively-interfered optical signal is generated. In contrast, when the delayed optical signal has a phase opposite to that of the first divided optical signal, a destructively-interfered optical signal is generated.

The balanced receiver 120 includes a plurality of photodiodes 121 and 122 for converting the interfered optical signals generated by the delay interferometer 110 into differential electrical signals, and an amplifier 123 for amplifying the differential electrical signals. The balanced receiver 120 detects the differential electrical signals from the constructively-interfered optical signal or the destructively-interfered optical signal. Here, the balanced receiver 120 recognizes the destructively-interfered optical signal as 0 bit and the constructively-interfered optical signal as 1 bit.

The power detector 130 may use an RF-power detector, etc., partially intensity-divides the differential electrical signal generated by the balanced receiver 120 and detects the power of alternating current component from the divided differential electrical signal.

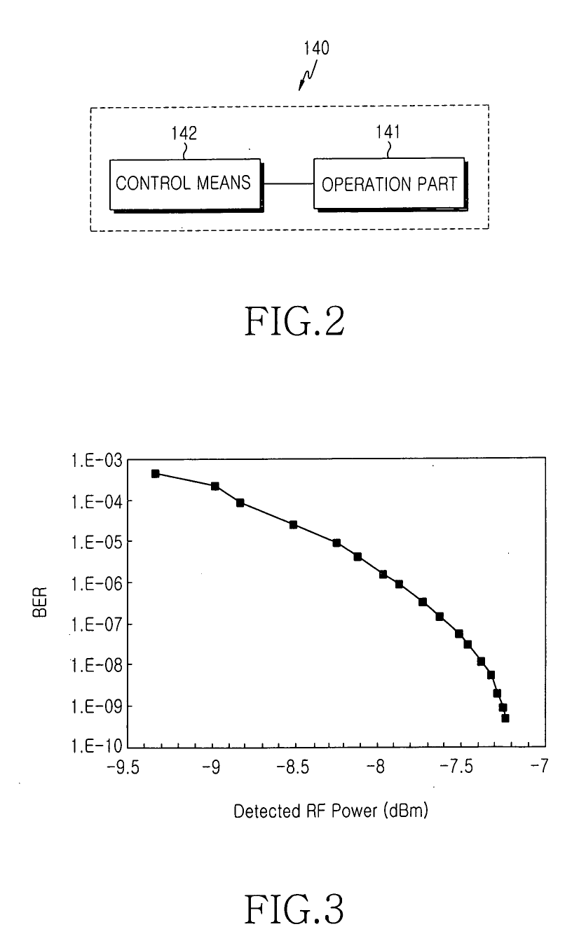

FIG. 2 is a block diagram showing the construction of the phase controller 140 shown in FIG. 1 and includes an operation part 141 and a control means 142. The phase controller 140 calculates a phase delay difference between the delayed optical signal and the first divided optical signal from the alternating current power detected by the power detector 130, then controls the phase delay difference between the first divided optical signal and the delayed optical signal to maintain one bit delay.

The operation part 141 calculates the phase delay difference between the delayed optical signal and the first divided optical signal from the alternating current power detected by the power detector 130, then generates a control signal for maintaining the phase delay of one bit between the delayed optical signal and the first divided optical signal.

The alternating current power of the differential electrical signal changes according to the phase relation of the interfered optical signals generated in the delay interferometer 110. For instance, when the phase delay difference of one bit between the first divided optical signal and the delayed optical signal is constantly maintained, the alternating current component of the differential electrical signal has a predetermined maximum value. In contrast, when the phase delay difference of one bit between the first divided optical signal and the delayed optical signal is off, the alternating current power of the differential electrical signal does not reach the predetermined maximum value, instead it is reduced.

FIG. 3 is a graph illustrating a relation of the alternating current power detected by the power detector 130 shown in FIG. 1 and a BER. In particular, FIG. 3 shows the BER of the alternating current power of the differential electrical signal detected by the power detector 130 when a differential modulated optical signal of 10 Gbps is received in the amplifier 123. In other words, the graph shown in FIG. 3 represents a relation of the alternating current power detected by the power detector 130 and the BER when the differential modulated optical signal has a power of −38.5 dBm.

When the phase delay difference of one bit between the first divided optical signal and the delayed optical signal is properly maintntaed, the BER has a value of 5×10⁻¹⁰. In such a case, the alternating current power detected by the power detector 130 has a power of −7.2 dBm. In contrast, when the phase delay difference of one bit between the first divided optical signal and the delayed optical signal is not maintained properly, the BER greatly increases. In such a case, the alternating current power of the differential electrical signal detected by the power detector 130 is attenuated to −8.5 dBm. Then, the operation part 141 outputs a control signal to the control means 142 in order to allow the alternating current power detected by the power detector 130 to have a maximum value.

The control means 142 controls the delay interferometer 110 to maintain the phase delay difference of one bit according to the control signal. Herein, the control means 142 may use a heater for applying the heat to the delay interferometer 110 so as to constantly maintain the phase delay difference between the first divided optical signal and the delayed optical signal, or a piezo-electric transducer for physically changing the length of one of the waveguides 111 and 112 of the delay interferometer 110 according to the control signal.

The heater or the piezo-electric transducer is attached to one of the waveguides 111 and 112 of the delay interferometer 110. The heater applies heat to a corresponding waveguide so as to change the refractive index of the waveguide and thus controls the phase delay difference between the first divided optical signal and the delayed optical signal to be constantly maintained. Further, the piezo-electric transducer physically controls the length of a corresponding waveguide according to the control signal.

According to the present invention as described above, an optical signal receiver monitors the phase delay difference of one bit between a first divided optical signal and a delayed optical signal generated in a delay interferometer from the alternating current power of a differential electrical signal, so that it is not necessary to artificially apply a direct current to a differential modulated signal. Further, according to the present invention, the optical signal receiver for receiving the differential modulated optical signal can use a mach-zehnder modulator as a delay interferometer.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. An optical signal receiver for receiving a differential modulated optical signal comprising:
a delay interferometer for intensity-dividing the optical signal into a first signal and a second optical signal, generating a delayed optical signal by phase-delaying the second optical signal by one bit, and generating interfered optical signals from the delayed optical signal and the first divided optical signal;
a balanced receiver for detecting a differential electrical signal from the interfered optical signals;
a power detector for detecting an alternating current power of the differential electrical signal; and
a phase controller for calculating a phase delay difference between the delayed optical signal and the first divided optical signal from the alternating current power detected by the power detector, and controlling the phase delay difference between the first optical signal and the delayed optical signal to be maintained constantly.

2. The optical signal receiver as claimed in claim 1, wherein the delay interferormeter includes a mach-zehnder interferometer including two or more waveguides having different phase lengths.

3. The optical signal receiver as claimed in claim 1, wherein the delay interferometer generates a constructively-interfered optical signal from the delayed optical signal and the first optical signal.

4. The optical signal receiver as claimed in claim 1, wherein the delay interferometer generates a destructively-interfered optical signal from the delayed optical signal and the first optical signal.

5. The optical signal receiver as claimed in claim 1, wherein the power detector includes an RF-power detector.

6. The optical signal receiver as claimed in claim 1, wherein the delayed optical signal and the first optical signal have a phase delay difference of π.

7. The optical signal receiver as claimed in claim 1, wherein the phase controller comprises:
an operation part for calculating the phase delay difference between the delayed optical signal and the first optical signal from the alternating current power and for generating a control signal to allow the phase delay difference to maintain a phase delay of one bit; and
a control means for controlling the delay interferometer to maintain the phase delay of one bit according to the control signal.

8. The optical signal receiver as claimed in claim 7, wherein the control means includes a heater for applying heat to the delay interferometer so as to constantly maintain the phase delay difference between the first optical signal and the delayed optical signal according to the control signal.

9. The optical signal receiver as claimed in claim 7, wherein the control means includes a piezo-electric transducer for physically changing the delay interferometer according to the control signal.

10. The optical signal receiver as claimed in claim 1, wherein the balanced receiver comprises:
a plurality of photodiodes for converting the interfered optical signals generated by the delay interferometer into differential electrical signals; and
an amplifier for amplifying the differential electrical signals.
